(19) United States
(12) Patent Application Publication
(10) Pub. No.: US 2009/0025633 A1
(43) Pub. Date: Jan. 29, 2009

(54) Small volume resist dispenser

(75) Inventors: Cornelis Martijn Johannes Ricken, Son en Breugel (NL); Patrick Wong, Schilde (BE); Ralf Martinus Daverveld, Sint-Oedenrode (NL); Jos Beerens, Reusel (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/216,988

(22) Filed: Jul. 14, 2008

Related U.S. Application Data
(60) Provisional application No. 60/935,013, filed on Jul. 23, 2007.

(51) Int. Cl. B05C 13/00; B05C 5/00

(52) U.S. Cl. 118/56; 118/300

(57) ABSTRACT

A small volume resist dispenser includes a suck-back capable pressure operated valve, connectable to a nozzle of a spin coater and to a controller output arranged to open and close the valve to control liquid supply to the spin-coater. The dispenser comprises a holder for a bottle and arranged to pressurize a fluid in the bottle by applying gas pressure. The dispenser is suitable for use with, for example, pre-filled resist sample bottles containing resist samples of 100 ml to 300 ml resist solution.

This application claims priority to and benefit from U.S. Provisional Patent Application No. U.S. 60/935,013, filed Jul. 23, 2007, the entire contents of which is hereby incorporated by reference.

### FIELD

The present invention relates to a small volume resist dispenser for a lithographic system.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In photolithography, a beam of radiation is patterned by having that beam traverse the patterning device, and is projected by a projection system of the lithographic apparatus onto a target portion (e.g., comprising one or more dies) on a substrate (e.g., silicon wafer) that has been coated with a layer of photo-activated resist (i.e., photoresist) material, such as to image the desired pattern in the resist. In general, a single substrate will contain a network of adjacent target portions that are successively patterned. Known lithographic apparatus include so-called scanners, in which each target portion is irradiated by scanning the pattern through a radiation beam in a given direction (the “scanning”-direction) while synchronously scanning the substrate parallel or anti-parallel to this direction.

In a factory, commonly referred to as a “fab” or “foundry”, in which, for example, semiconductor devices are manufactured, each lithographic apparatus is commonly grouped with a “track” comprising substrate handling devices and pre- and post-processing devices to form a “lithocell”. Substrates, which may be blank or have already been processed to include one or more process or device layers, are delivered to the lithocell in lots (also referred to as batches) for processing. A lot is, in general, a group of substrates which are to processed by the lithocell in the same way and is accompanied by a “recipe” which specifies the processes to be carried out. The lot size may be arbitrary or determined by the size of carrier used to transport substrates around the fab. The recipe may include details of the resist coating to be applied, a temperature and a duration of pre- and post-exposure bakes to be applied, details of the pattern to be exposed, the exposure settings, for example, for the pattern exposure, and a development duration.

### SUMMARY

A process to be carried out in the track may be the dispensing of an amount of fluid material such as a resist solution onto a substrate. A resist solution reservoir, containing about a gallon of liquid resist solution, is connected via a bellows pump and a valve system to a nozzle to apply the resist solution to the substrate. A controller of the track is configured to provide pressure signals to the valve system to regulate a flow of resist solution. For application of a suitable amount of resist solution (such as 6 ml of resist solution) to a single substrate, a track may be equipped with a small volume fluid dispenser arrangement including a diaphragm pump. A diaphragm pump does not enable dynamic coating of a substrate (e.g. spin coating) because such a pump delivers resist solution in pulses of +/−0.5 ml at a time. To coat a substrate without spinning, such a pump provides a puddle of about 6 ml resist solution to the substrate. This method, however, is prone to causing contamination and resulting defects in the printed pattern.

It is desirable, for example, to provide a small volume fluid dispenser system that may alleviate contamination and/or pattern defects.

According to an aspect of the invention, there is provided a small volume chemical solution dispenser for use with a lithographic track apparatus, comprising a fluid communication member having a sealing surface provided with a first and a second fluid communication opening, and a member constructed and arranged to press, in use, a reservoir containing a sample of the chemical solution against the sealing surface such as to connect an inner volume of the reservoir with the first and second fluid communication opening.

According to an aspect of the invention, there is provided a track apparatus, comprising a spin coater configured to apply a chemical solution to a substrate, the spin coater comprising a nozzle configured to supply the chemical solution to the substrate, wherein the nozzle is connected, via a fluid conduit, to a suck-back capable valve of a small volume chemical solution dispenser including a fluid communication member having a sealing surface provided with a first and a second fluid communication opening, and a member constructed and arranged to press, in use, a reservoir containing a sample of the chemical solution against the sealing surface such as to connect an inner volume of the reservoir with the first and second fluid communication opening, the first fluid communication opening being connected to the nozzle via the suck-back capable valve and a fluid conduit, and the second fluid communication opening being connectable to a device constructed and arranged for supplying pressure to the inner volume via a fluid conduit.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithocell including a lithographic apparatus and a track, the track including a small volume resist solution dispenser;

FIG. 2 depicts a small volume resist solution dispenser according to an embodiment of the invention; and

FIG. 3 illustrates the lithographic apparatus shown in FIG. 1 in more detail.

### DETAILED DESCRIPTION

In lithography there is a need to apply improved photoresist for printing patterns at smaller critical dimension. For testing new lithographic printing processes based on improved resist, resist vendors supply small samples (100 ml to max. 300 ml) of resist solution. With these small samples, a substrate needs to be coated with as little resist solution volume as possible (1.5-2 ml is desirable) to be able to coat up to 65 substrates with a 100 ml sample of resist solution. To coat a substrate with such a small volume of resist solution, the coat process is desirably a spin coating process wherein the substrate is rotated (spinned) while applying the resist solution (referred to herein as dynamic coating).

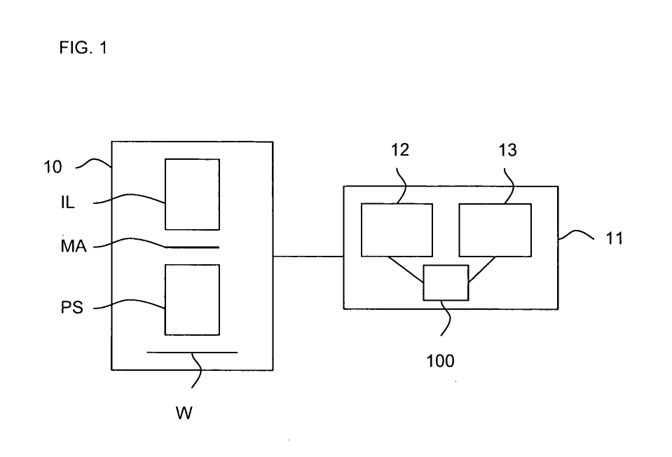

FIG. 1 schematically depicts a lithographic apparatus 10 connected to a track 11 including a spin coater 12, a track controller 13 and a small volume resist dispenser 100. The controller 13 of the track 11 is configured to provide pressure signals to a valve system of the small volume resist dispenser to regulate a flow of resist solution. The lithographic apparatus 10 includes an illumination system IL to illuminate a patterning device MA, and a projection system PS to project patterned radiation onto a substrate W.

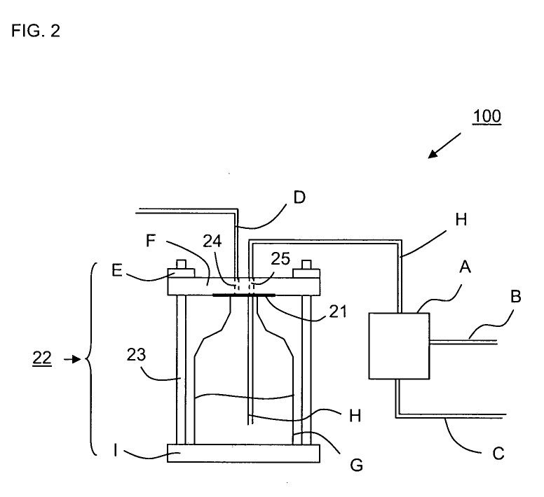

A small volume resist dispenser 100 according to an embodiment of the invention is schematically illustrated in FIG. 2. The small volume resist dispenser 100 includes a suck-back capable pressure operated valve A, connectable to a nozzle of the spin coater 12 and to the track controller 13. An output signal of the track controller 13 is a pressure signal used to open and close the valve A to control fluid (e.g., liquid) supply to the spin coater 12. The dispenser 100 comprises a holder for a bottle and is arranged to pressurize a fluid in the bottle by applying gas pressure. The dispenser is suitable for use with pre-filled resist-sample bottles containing resist samples of 100 ml to 200 ml resist solution.

The suck-back capable pressure operated valve A is constructed and arranged to start and stop a dispensing of resist solution via a fluid conduit such as tubing C which is connected to a nozzle of the spin coater 12 (not shown in FIG. 2). The valve A can be operated by the controller 13 of the track 11. A sample bottle G partially filled with resist solution, e.g., a sample of resist solution supplied by a resist vendor, is placed with its opening in contact with a fluid communication member F. The fluid communication member may be embodied as a material plate with a sealing surface 21, such that upon pressing the bottle into the sealing surface 21 the opening of the bottle G is sealed. The sealing surface 21 may be embodied as a layer of resilient material applied to the fluid communication member F. A member 22 constructed and arranged to press the bottle G against the sealing surface 21 may, for example, include a movable closing member I arranged to accommodate different sized bottles G. For example, member 22 may include a plate as the closing member I, nuts E and threaded wires 23. The bottle G can be held firmly in place between members I and F by tightening nuts E (of which two are shown in FIG. 2).

Fluid communication with the sealed bottle G is possible via a first fluid communication opening 24 and second fluid communication opening 25. The fluid communication openings 24 and 25 are disposed in the fluid communication member F in such a way that an inner volume of the bottle G is connected to these openings. The sample bottle G can be pressurized via the first opening 24 by applying pressure of an inert fluid to an inner volume of the bottle G, via a fluid conduit D connected to a device constructed and arranged to supply an inert, compressible fluid. The inert fluid may, for example, be an inert gas, such as nitrogen. In the embodiment, nitrogen gas in the bottle G may have a pressure at any value within 0.5 and 1.3 Bar. A maximum allowable pressure for a conventional sample bottle may be 10 Bar, so that safety should be guaranteed at an operating pressure within the aforementioned range of pressures.

The track controller 13 is constructed and arranged to apply pressure and to relieve pressure on fluid conduit B shown in FIG. 2. The suck-back capable valve A is responsive to such a change of pressure signal so as to respectively open and close valve A when the pump is used to deliver resist solution to the spin coater 12. When the valve is open, the resist solution flows from the bottle G through conduit H, connected between the second fluid communication opening 25 and the valve A, to the valve A and via a fluid conduit C to the dispense nozzle of the spin coater 12.

Parts of the dispenser 100 exposed to resist solution are embodied of a material resistant to the solvent in the resist solution, such as TEFLON™ fluoropolymer, and reduce the risk of defects. The valve used can be, for example, a SMC LVD13U-S032 valve produced by SMC Corporation of America. A dispense through a steady flow without a pulsating flow-component can be provided. Dispense volumes in the range of 0.25 ml and up and desirably in the range of 0.25 ml up to 1.5 ml can be provided, wherein the relatively low dispense volume enables dynamic coating of the substrate or use for alternative ways of coating a substrate.

In the dispenser system 100, the bottle G can be disconnected and stored for later use, with an advantage that no substantial quantity of resist solution is lost in such circumstances. The fluid communication member F, embodied as a plate, when pressed against the bottle G, provides an arrangement such that different bottles of different size and shape can be used. For example, a pre-filled bottle containing a resist solution sample of, for example 100 or 200 ml, can be connected to the conduits D and H without a need to transfer the content of the sample bottle to a reservoir which is part of a conventional liquid dispenser used in a track for spin coating. This may alleviate a problem of contamination and loss of resist solution.

A small volume dispenser system for use with a track includes a syringe based pump, or a manually operated dispenser such as a pipette, or the aforementioned diaphragm pump. With a pipette, it is not possible to coat a 300 mm diameter substrate because the pipette does not fit inside a coating track, and for a 200 mm diameter substrate it is unsafe to work with a pipette because safety windows have to be taken off the track. An embodiment of the present invention may alleviate this problem. Also, with a pipette it is not possible to coat a substrate dynamically because a minimum of 5 ml resist solution is applied. A syringe based fluid pump has as a drawback that it has to be operated by hand. In contrast, the dispenser according to an embodiment of the invention may be connected to a track pressure signal corresponding to line B, which is commonly available with a track. A low volume dispense unit for use with a track and including a pneumatic syringe can be gleaned from U.S. Pat. No. 6,857,543. The pneumatic syringe is used as a reservoir for a small volume (e.g. 30 cc) of resist solution to be applied to a batch of substrates. In contrast to the present embodiment, the use of the pneumatic syringe implies a need to transfer resist solution from a bottle containing the resist-sample (as provided by a resist vendor) to the syringe. During the transfer, there is a risk of contamination of resist and of loss of resist. The present embodiment further avoids a desired cleaning or replacing of the pneumatic syringe, thereby reducing cost of operation of the small volume dispenser.

An embodiment of the invention has been described in relation to a track apparatus. However, the small volume resist dispenser 14 and the track 11 may be separate devices. For example, the small volume resist dispenser 14 may be used standalone or in a different apparatus (e.g., a lithographic apparatus).

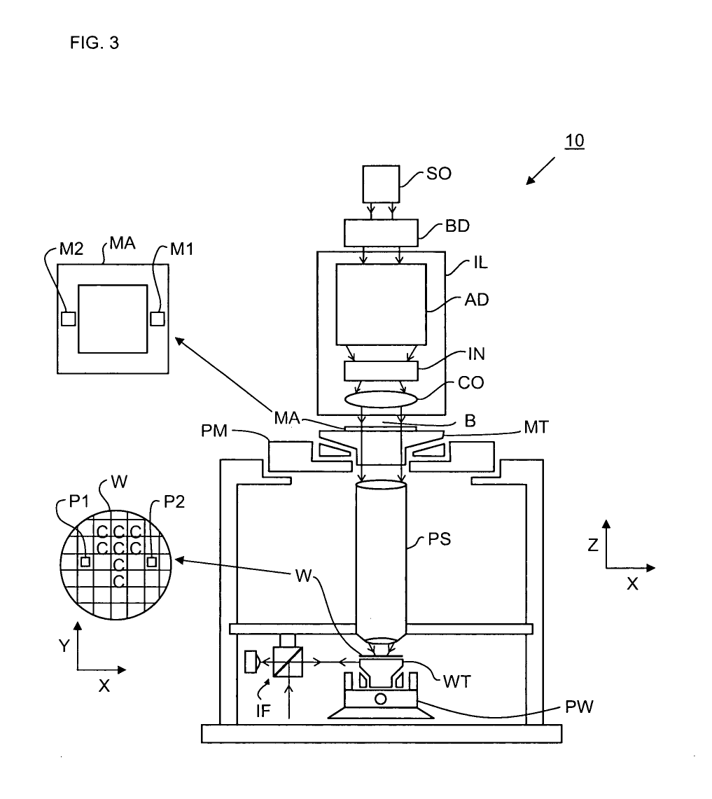

A lithographic apparatus 10 of a lithographic cluster as illustrated in FIG. 1 is illustrated in FIG. 3. The apparatus 10 comprises:

an illumination system (illuminator) IL configured to condition a radiation beam B (e.g. ultraviolet (UV) radiation such as generated by an excimer laser operating at a wavelength of 248 nm or 193 nm, or extreme ultraviolet (EUV) radiation as generated by, for example, a laser-fired plasma source operating at 13.6 nm wavelength);

a support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist-coated wafer) W and connected to a second positioner PW configured to accurately position the substrate in accordance with certain parameters; and

a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device. It holds the patterning device in a manner that depends on the orientation of the patterning device, the design of the lithographic apparatus, and other conditions, such as for example whether or not the patterning device is held in a vacuum environment. The support structure MT can use mechanical, vacuum, electrostatic or other clamping techniques to hold the patterning device. The support structure MT may be a frame or a table, for example, which may be fixed or movable as required. The support structure MT may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus 10 is of a transmissive type (e.g. employing a transmissive mask). Alternatively, the apparatus may be of a reflective type (e.g. employing a programmable mirror array of a type as referred to above, or employing a reflective mask).

The lithographic apparatus 10 may be of a type having two (dual stage) or more substrate tables (and/or two or more patterning device tables). In such “multiple stage” machines the additional tables may be used in parallel, or preparatory steps may be carried out on one or more tables while one or more other tables are being used for exposure.

The lithographic apparatus 10 may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 3, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as R-outer and v-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. Having traversed the patterning device MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus 10 could be used in at least one of the following modes:

In step mode, the support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

In scan mode, the support structure MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

Although specific reference may be made in this text to use in the manufacture of ICs, it should be understood that the apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm) as well as particle beams, such as ion beams or electron beams. The term “lens”, where the context allows, may refer to any one or combination of various types of optical components, including refractive and reflective optical components.

While specific embodiments of the invention have been described above, it will be appreciated that the invention may be practiced otherwise than as described. For example, the bottle G may be any fluid reservoir used by a supplier of a sample chemical solution to distribute the sample. The invention is not limited to a small volume dispenser for resist solution. Instead of resist solution, the sample bottle may contain a sample of any chemical solution for use with processing substrates, such as siloxane, silicate, or hydrogensylsesquioxane mixed in an alcohol based solvent.

The descriptions above are intended to be illustrative, not limiting. Thus, it will be apparent to one skilled in the art that modifications may be made to the invention as described without departing from the scope of the claims set out below.

1. A small volume chemical solution dispenser for use with a lithographic track apparatus, comprising:
a fluid communication member having a sealing surface provided with a first fluid communication opening and a second fluid communication opening; and
a member constructed and arranged to press, in use, a reservoir containing a sample of the chemical solution against the sealing surface such as to connect an inner volume of the reservoir with the first and second fluid communication openings.

2. The dispenser of claim 1, wherein the reservoir is a bottle.

3. The dispenser of claim 2, wherein the bottle has a volume selected from the range of 100-300 ml.

4. The dispenser of claim 3, wherein the bottle is a sample bottle in which a sample of the chemical solution is supplied by a supplier of the chemical solution.

5. The dispenser of claim 1, wherein the first fluid communication opening is connected to a suck-back capable valve via a fluid conduit and the second fluid communication opening is connectable to a device configured to supply pressure to the inner volume via a fluid conduit.

6. The dispenser of claim 5, wherein the reservoir is a bottle.

7. The dispenser of claim 6, wherein the bottle has a volume selected from the range of 100-300 ml.

8. The dispenser of claim 7, wherein the bottle is a sample bottle in which a sample of the chemical solution is supplied by a supplier of the chemical solution.

9. The dispenser of claim 1, wherein the chemical solution is a photo resist solution.

10. A track apparatus, comprising a spin coater configured to apply a chemical solution to a substrate, the spin coater comprising a nozzle configured to supply the chemical solution to the substrate, wherein the nozzle is connected, via a fluid conduit, to a suck-back capable valve of a small volume chemical solution dispenser, the small volume chemical solution dispenser including:
a fluid communication member having a sealing surface provided with a first fluid communication opening and a second fluid communication opening, and
a member constructed and arranged to press, in use, a reservoir containing a sample of the chemical solution against the sealing surface such as to connect an inner volume of the reservoir with the first and second fluid communication openings,
wherein the first fluid communication opening connected to the nozzle via the suck-back capable valve and a fluid conduit, and the second fluid communication opening is connectable to a device configured to supply pressure to the inner volume via a fluid conduit.

11. The track apparatus of claim 10, wherein a valve-open or valve-closed state of the suck-back capable valve is responsive to a change of a pressure signal, and further comprising a controller configured to provide an output signal that is the pressure signal.

12. The track apparatus of claim 10, wherein the reservoir is a bottle.

13. The track apparatus of claim 12, wherein the bottle has a volume selected from the range of 100-300 ml.

14. The track apparatus of claim 13, wherein the bottle is a sample bottle in which a sample of the chemical solution is supplied by a supplier of the chemical solution.

15. The track apparatus of claim 10, wherein the device configured to supply pressure to the inner volume via a fluid conduit is a part of the track.

16. The track apparatus of claim 10, wherein the chemical solution is a photo resist solution.
